(19) United States
(12) Patent Application Publication
(10) Pub. No.: US 2024/0391542 A1
(43) Pub. Date: Nov. 28, 2024

(54) TUNABLE MOTION USING FLEXIBLE TWISTED BEAMS

(71) Applicants: Daniel Aukes, Gilbert, AZ (US); Yuhao Jiang, Tempe, AZ (US); Fuchen Chen, Mesa, AZ (US)

(72) Inventors: Daniel Aukes, Gilbert, AZ (US); Yuhao Jiang, Tempe, AZ (US); Fuchen Chen, Mesa, AZ (US)

(21) Appl. No.: 18/674,101

(22) Filed: May 24, 2024

Related U.S. Application Data
(60) Provisional application No. 63/504,102, filed on May 24, 2023.

(51) Int. Cl. B62D 57/02

(52) U.S. Cl. CPC B62D 57/02

(57) ABSTRACT

A robotic device includes a flexible beam, a body coupled to a first end of the flexible beam, and a foot coupled to a second end of the flexible beam. The flexible beam defines a longitudinal axis along the length of the flexible beam from the first end to the second end. The longitudinal axis is perpendicular to a first axis along a width of the first end and a second axis along a width of the second end, and a twist angle of the flexible beam is defined by an angle between the first axis and the second axis in a plane perpendicular to the longitudinal axis. Vibrating the flexible beam includes subjecting a first end of the flexible beam to a linear vibratory input at a selected input frequency, thereby generating a repeating, semicircular trajectory at a second end of the flexible beam.

### CROSS-REFERENCE TO RELATED APPLICATION

This application claims the benefit of U.S. Patent Application No. 63/504,102 filed on May 24, 2023, which is incorporated herein by reference in their entirety.

### STATEMENT OF GOVERNMENT SUPPORT

This invention was made with government support under grant number 1935324 awarded by the National Science Foundation. The government has certain rights in the invention.

### TECHNICAL FIELD

This invention relates to methods of generating motion by propagating vibrations through flexible twisted beams, and robots that use these methods.

### BACKGROUND

Soft robots use soft and extensible materials that allow for large and continuum-like deformation throughout the robot body. The reconfigurablity of soft robots allows them to bend and deform to adapt to their environment. Unlike actuation in traditional rigid-body robotic systems, which relies on motors, gears, shafts, and belts to actuate and transmit power, the morphology of soft actuators can be deformed to alter body shapes and drive robots by stimulating or deforming soft materials.

### SUMMARY

This disclosure relates to design, fabrication, and performance of flexible twisted beams and their use to generate motion in soft continuum robots. The motion involves propagating one-dimensional vibration through flexible twisted beams and using dynamically coupled anisotropic stiffness to generate directional motion in soft robots. The coupled stiffness of twisted beams with terrain contact can be controlled to generate a variety of complex trajectories by changing the frequency of the input actuating signal. The disclosed flexible twisted beams produce a tunable walking gait from a single vibrational input. By taking advantage of the shape and material properties in flexible structures, actuation signals for generating complex motion can be consolidated and simplified.

In a first general aspect, a robotic device includes a flexible beam, a body coupled to a first end of the flexible beam, and a foot coupled to a second end of the flexible beam. The flexible beam defines a longitudinal axis along the length of the flexible beam from the first end to the second end. The longitudinal axis is perpendicular to a first axis along a width of the first end and a second axis along a width of the second end, and a twist angle of the flexible beam is defined by an angle between the first axis and the second axis in a plane perpendicular to the longitudinal axis.

Implementations of the first general aspect may include one or more of the following features. The robotic device can include an actuator coupled to the body and configured to translate the body back and forth, thereby moving the flexible beam at a selected input frequency along the first axis. The foot can be configured to contact a surface and advance the robotic device along the surface. A direction and speed of the robotic device along the surface is based at least in part on the selected input frequency. The selected input frequency is typically in a range of about 1 Hz to about 100 Hz. Some implementations of the robotic device include a motor operatively coupled to the actuator.

In a second general aspect, vibrating a flexible beam includes subjecting a first end of the flexible beam to a linear vibratory input at a selected input frequency, thereby generating a repeating, semicircular trajectory at a second end of the flexible beam. The flexible beam defines a longitudinal axis along the length of the flexible beam from the first end to the second end. The longitudinal axis is perpendicular to a first axis along a width of the first end and a second axis along a width of the second end, and a twist angle of the flexible beam is defined by an angle between the first axis and the second axis in a plane perpendicular to the longitudinal axis.

Implementations of the second general aspect may include one or more of the following features.

The second end of the flexible beam is coupled to a member, and the member is configured to contact a surface. The member is configured to contact the surface to yield a complex motion at the surface. The complex motion is adapted for robot walking along the surface, and defines a contact frequency of a contact point at a surface. The contact frequency is a function of the selected input frequency. The frequency of the linear vibratory input can be selected (e.g., in a range of about 1 Hz to about 100 Hz), and the direction of motion at the contact point and a resulting motion path are a function of the selected input frequency. Subjecting the first end of the flexible beam to a linear vibratory input includes translating the first end of the flexible beam in a plane parallel to a surface of the first end of the flexible beam at the selected input frequency.

Implementations of the first and second general aspects may include one or more of the following features.

The twist angle has a magnitude of up to about 90°. The flexible beam can be composed of a material having a Shore hardness in a range of about 90A to about 100A, a material with a Young's modulus in a range of about 5 MPa to about 30 MPa, or both. In some cases, the flexible beam is composed of a thermoplastic elastomer, a thermoplastic polyurethane, or both.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1A and 1B show input actuation and resulting motion of a flexible twisted beam without terrain contact and with terrain contact, respectively.

FIG. 2 shows a plot of single beam contact frequency as a function of input frequency.

FIG. 3 illustrates design parameters of a flexible twisted beam.

FIG. 4 depicts an apparatus used to test flexible twisted beams.

FIGS. 5A and 5B show results from finite element analysis (FEA) simulations. FIG. 5A shows a beam FEA mesh model, and FIG. 5B shows a beam with right-handed (ϕ=90°) and left-handed (ϕ=−90°) chirality.

FIG. 6 shows plots of major and minor axis lengths of beam end point trajectory with respect to twist angle ϕ obtained from finite element analysis (FEA) simulations.

FIGS. 7A and 7B shows a proposed analytical model and a simplified analytical model, respectively, obtained from finite element analysis (FEA) simulations.

FIGS. 8A and 8B show plots of contact force data in two directions from single beam contact tests.

### DETAILED DESCRIPTION

This disclosure describes walking robots actuated using the coupled compliance of flexible twisted beams with surface contact. The mechanism transforms simple, periodic input motion into complex cyclic motions when contact is made with the surface. Complex motion refers to movements resulting from the interaction between the flexible twisted beams and a surface, characterized by varying frequencies, directions, and patterns of motion. The method can be adopted to generate tunable forward and backward walking by controlling parameters including the input frequency. By taking advantage of the shape and material properties in flexible structures, actuation signals for generating complex motion can be consolidated and simplified.

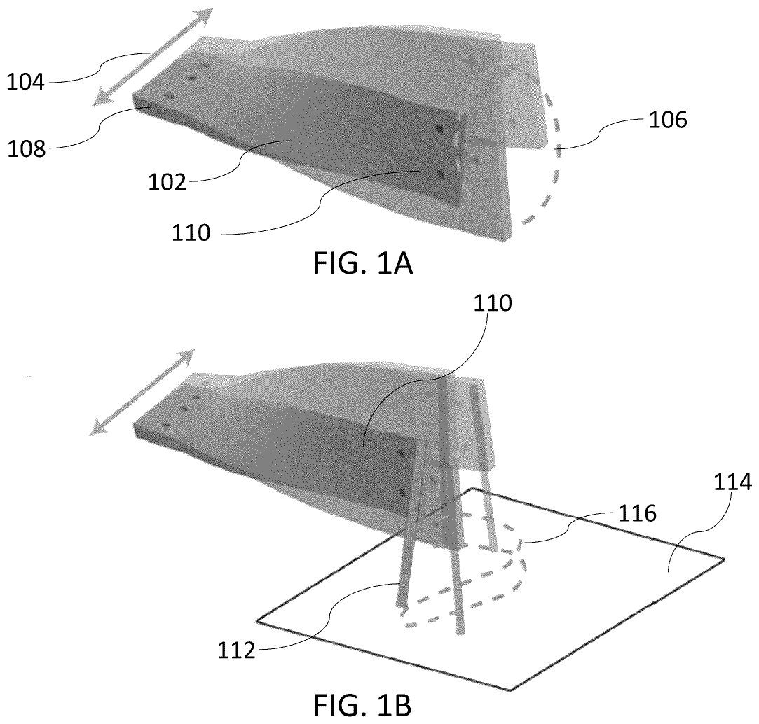

FIGS. 1A and 1B depict the vibration propagation of a flexible twisted beam. As used herein, a beam is an elongated structural element designed to transfer motion through bending or twisting. Beams can be used to achieve controlled movement and distribute forces. Beams can be used in robotic devices to generate complex motions through vibratory input. A beam may have various cross-sectional shapes, including rectangular, cylindrical, I-shaped, T-shaped, C-shaped, box-shaped (hollow structural sections (HSS)), angle-shaped (or L-beams), or elliptical.

Beams are typically made from materials including thermoplastic elastomer (TPE), thermoplastic polyurethane (TPU), or a combination thereof. Other suitable materials include silicone rubber, polyethylene (PE), polyvinyl chloride (PVC), nylon, ethylene vinyl acetate (EVA), polyester elastomers, or any combination thereof. Measurements such as Shore hardness and Young's modulus are used to determine the beam's flexibility and stiffness, respectively. The Shore hardness of the selected material is typically in a range of about 90A to about 100A. The Shore hardness is typically 92A for thermoplastic elastomer (TPE) and 95A for thermoplastic polyurethane (TPU). The Young's modulus of the selected material is typically in a range of about 5 MPa to about 30 MPa.

Beams can be fabricated using 3 D printing to reduce manufacturing time and enable a broad design space. Soft printable materials can be selected for printing at millimeter to centimeter scales, with the capability of creating structures more than 30 layers thick. Thermoplastic elastomer (TPE) and thermoplastic polyurethane (TPU) are examples of materials that can be used for 3 D printing of beams due at least in part to desirable mechanical properties such as flexibility, stiffness, durability, and the ability to withstand repeated loading without significant deformation. 3 D printing allows for control over the beam's dimensions and material properties, allowing beams with a desired range of stiffness and flexibility to be manufactured.

Beams can be fabricated in various lengths, widths, and thicknesses depending on the specific application requirements. The dimensions of a beam can play a role in the mechanical properties such as flexibility and stiffness. Adjusting the beam's dimensions allows for customization of the beam's behavior.

A flexible beam can bend or deform under applied forces (e.g., bending, and torsional forces) without breaking. Flexibility in beams is achieved by selecting materials, designs, and dimensions that allow the beam to bend or deform under applied forces without breaking. Beams can be designed with various twist angles to achieve desired motion characteristics. Twisting refers to the rotation of one end of the beam relative to the other end around the beam's longitudinal axis. The twist angle is the measure of the rotation and can be adjusted to influence the beam's vibration response, resonance frequencies, damping characteristics, deflection, deformation, and stability under dynamic loads. Different twist angles can be used to tailor the beam's performance to meet specific requirements, such as load-bearing capacity, flexibility, stiffness, resonance frequencies, damping properties, durability, and precision of motion.

Beams can exhibit various types of motion, including bending, twisting, and vibrating, in response to applied forces. Vibration propagation in beams involves the transmission of oscillatory motion from one end to the other. When a beam is subjected to a vibratory input, the beam can generate complex motion patterns depending on the beam's material properties, dimensions, and twist angles. The complex motion patterns are influenced by the input frequency and the dynamic behavior of the beam, including vibration response, resonance, and damping characteristics.

Referring to FIG. 1A, a flexible twisted beam 102 under a linear vibratory input 104 generates a repeating, semi-circular trajectory at the tip 106. The linear vibratory input 104 refers to the periodic motion of the beam induced by an external input. Subjecting the proximal end 108 of the flexible twisted beam 102 to a linear vibratory input 104 includes translating the proximal end 108 of the flexible twisted beam 102 in a plane parallel to a surface of the proximal end 108 of the flexible twisted beam 102 at the selected input frequency. Linear vibratory input frequencies can be selected to achieve desired contact frequency and motion of the flexible twisted beam. An input actuator can translate the proximal end 108 of the beam along the plane parallel to a surface of the proximal end 108 of the flexible twisted beam 102 and generate a repeating, semicircular trajectory at a distal end 110 of the flexible twisted beam 102. As shown in FIG. 1B, the distal end 110 of the flexible twisted beam 102 is coupled to a member 112 (e.g., a rigid foot) configured to contact a surface 114. Other suitable members include a contact pad, end effector, load cell, support plate, anchor, or the like. The member 112 is configured to contact the surface 114 to yield a complex motion at the surface 114. When supplied an input frequency, the member 112 contacts the surface 114 in a repeating, semi-circular trajectory resulting in a more complex motion 116 that can be further adapted for robot walking along the surface 114.

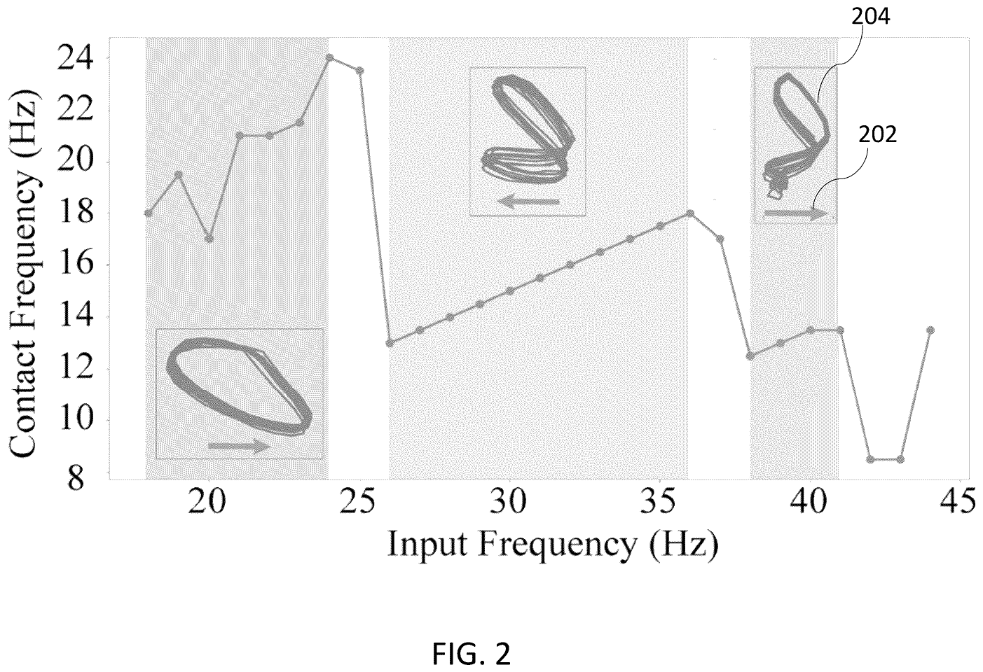

FIG. 2 shows that the contact frequency, direction of motion 202 at the contact point, and pattern 204 of the resulting motion path can be controlled at least in part by the input frequency. The contact frequency (Hz) is a function of the selected input frequency (Hz), and the contact frequency contributes to the complex motion of a contact point on the surface. Three contact frequency regimes are observed and highlighted in FIG. 2. Contact frequencies measured with input driving frequencies from 18 Hz to 44 Hz are shown in FIG. 2. In each regime, the contact frequency increases with the input frequency. At the transition frequencies of 26 Hz and 38 Hz, the contact frequency drops by ½ and ⅓, respectively. At the transition frequencies of 26 Hz and 38 Hz the member's trajectory inverts and then reverses the direction of motion (and force) on the surface. The member is configured to contact the surface and advance the robotic device along the surface. The interaction of the flexible twisted beam with the surface at different input frequencies can produce various motion patterns. The patterns or trajectories evolve as a function of input frequency as shown in FIG. 2.

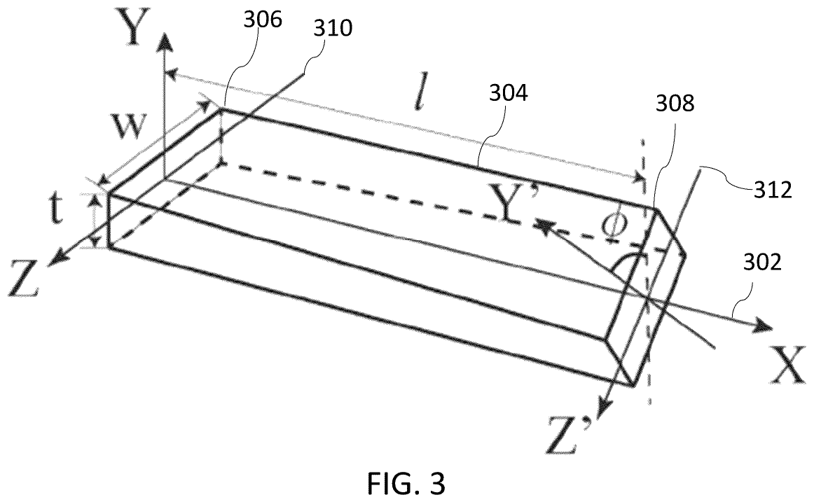

Beams can be fabricated using design parameters as shown in FIG. 3. Design parameters for a flexible twisted beam include a longitudinal axis 302 along the length of the flexible twisted beam 304 from the proximal end 306 to the distal end 308, where the longitudinal axis 302 is perpendicular to the Z-axis 310 along the width of the proximal end 306 and perpendicular to the Z′-axis 312 along a width of the distal end 308.

A flexible twisted beam can have a twist angle (ϕ) of approximately about 90°. Twisting refers to the rotation of one end of a flexible beam (e.g., the distal end 308) relative to the other end of the flexible beam (e.g., the proximal end 306) around the longitudinal axis 302 of the flexible beam. The twist angle refers to the angle between the Z-axis 310 and the Z′-axis 312 in a plane perpendicular to the longitudinal axis 302.

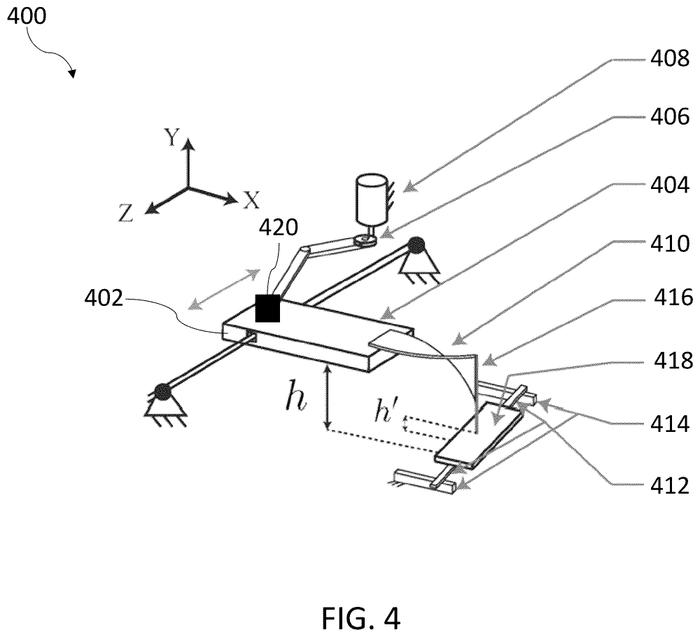

An exemplary robotic device 400 depicted in FIG. 4 includes a body 402 with a translational stage 404 where oscillating, forward-backward motion can be created by the rotating crank 406 of a brushless motor 408. The proximal end of the flexible twisted beam 410 of the robotic device 400 can be mounted to translational stage 404 of the body 402 and optical tracking markers can be mounted to the proximal and distal ends of the beam. An optical motion tracking system can be used to track the position of the robotic device 400. Two pair of load cells, load cell pair Y 412 and load cell pair Z 414, can be mounted to measure contact forces between the flexible twisted beam 410 and a surface along the Y and Z axes normal and tangential to the surface, respectively. A member 416 (e.g., a rigid foot) can be mounted to the distal end of the flexible twisted beam 410 to create contact with a surface. The distance between the translational stage 404 and the contact plate 418 is depicted in FIG. 4 as h. The contact distance between the rigid foot 416 at an unloaded, natural position and the contact plate 418 is depicted in FIG. 4 by h′. An actuator 420 can be coupled to the body and operatively coupled to the brushless motor 408. The actuator 420 can be configured to translate the body back and forth creating a movement of the flexible twisted beam 410 at a selected input frequency along the Z-axis. The robotic device 400 can have an input frequency that varies from about 1 Hz to about 100 Hz. Other suitable input frequencies can include from about 1 Hz to about 50 Hz.

The mechanisms for establishing complex dynamics using flexible and compliant twisted beams disclosed herein can be tuned via geometric, inertial, and material parameters and used to simplify the control signals typically associated with multi-degrees-of-freedom walking robots.

### EXAMPLES

System modeling. Beams used in fabrication of structures and devices are typically engineered at right angles. The stiffness of beams, when analyzed, can typically be understood by the orthogonal components of a 3 D stiffness matrix. The stiffness of an I-beam, for example, can be engineered to maximize stiffness and strength against gravity-based loads while being softer in lateral directions. The X, Y, and Z components of beams' stiffness matrices are typically considered independently in simple analyses due at least in part to their coupling terms are small or near zero. When beams are twisted, their reaction forces and subsequent deflections can become coupled by asymmetric material couplings.

This disclosure uses static data to derive a linear stiffness model of the behavior of coupling due at least in part to the twist in a beam. This model can be represented as

$$[ \begin{matrix}{F}_{v} \\ {F}_{z} \\ {M}_{x}\end{matrix} ] = {K}^{′} [ \begin{matrix}{X}_{y} \\ {Y}_{z} \\ {θ}_{x}\end{matrix} ] , where \qquad ( 1 )$$

$${K}^{′} = [ \begin{matrix}{k}_{yy} & {k}_{yz} & {m}_{yx} \\ {k}_{zy} & {k}_{zz} & {m}_{zx} \\ {t}_{xy} & {t}_{xz} & {n}_{xx}\end{matrix} ] . \qquad ( 2 )$$

where k terms represent the linear coupling between orthogonal directions in N/m, m terms represent the coupling between twist and force in N/rad, t terms represent the coupling between linear displacement and moment in N-m/m, and 1xx represents the coupling between twist and moment in N-m/rad. A static, fixed-displacement test was conducted to measure the beam's shear force and bending moments at different positions on beams with twist angle ϕ=0°, ϕ=±45°, and ¢=±90°.

$${K}_{ϕ = 0 °}^{′} = [ \begin{matrix}5504.72 & 28.19 & - 0.20 \\ 10.79 & 559.69 & 0.73 \\ 00.04 & 0.66 & 0.10\end{matrix} ] \qquad ( 3 )$$

$${K}_{ϕ = 90 °}^{′} = [ \begin{matrix}2231.54 & 439.96 & 0.83 \\ 457.14 & 2113.52 & - 1.37 \\ 0.68 & 1.32 & 0.22\end{matrix} ] \qquad ( 4 )$$

Examining the difference between K_{ϕ=0°}^{′} and K_{ϕ=90°}^{′}, k_{yy} and k_{zz} terms are larger for the beam with twist angle ϕ=0° while k_{zy} and k_{zy} coupling terms are low. The straight beam deforms along the directions of the input load, rather than in orthogonal directions. In the case with ϕ=90°, the larger k_{yz} and k_{zy} terms indicate larger coupling between axes. Beams that twist or flex can deform and react in the direction of their input forces. Flexible twisted beams deform and react in other directions as well. Single-direction forces can be transformed into coupled motion flexible twisted beams, and where, in simple models, the parameters that describe this phenomenon reside.

Finite element analysis modeling. Finite element analysis (FEA) and analytical modeling approaches were used to analyze the dynamic behavior of the disclosed flexible twisted beam vibration as well as the resulting motion when interacting with the terrain surface. The FEA simulation results demonstrate the resulting motion of the vibrating flexible twisted beam as a function of twist angle and driving frequency. The pseudo-rigid-body model demonstrates the walking locomotion of the vibrating flexible twisted beam with terrain contact as a function of driving frequency.

A series of dynamic simulations were conducted with an FEA model. The simulations demonstrate how input frequency, beam chirality, and the magnitude of beam twist angle ϕ alter the dynamic motion of the beam.

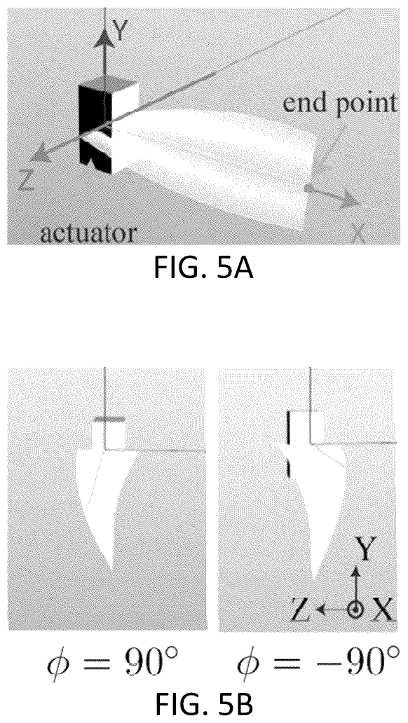

The finite element model (FEM) used to simulate flexible twisted beam dynamics is depicted in FIG. 5A. The FEM included a 120-element mesh generated from a single layer of 6-field Reissner-Mindlin shells. The mesh geometry replicated the disclosed beam design. The material properties used in the model were provided by the datasheet of the thermoplastic polyurethane used to fabricate the beams.

The input actuator shakes the proximal end of the flexible twisted beam along the Z-axis as shown in FIG. 5A. The input signal is represented by

$$x = A sin ( 2 π ft ) , \qquad ( 5 )$$

where x is the actuation travel position with the unit of mm, f is the rotating frequency of the actuator in Hz and A is the amplitude in mm with A=2 mm.

Input frequency versus resulting motion. The coupled stiffness of twisted beams can be used by actuation at specific frequencies to create differentiated motion. The input frequency was swept from ƒ=1 Hz to ƒ=45 Hz in 1 Hz increments. The trajectory of the beam's distal end was recorded throughout the simulation. The beam's trajectory varied in shape and size as a function of input frequency. At input frequencies such as 9 Hz, 17 Hz, 25 Hz, the trajectory exhibited an oval-like shape. At frequencies such as 1 Hz and 41 Hz the trajectory appeared more linear.

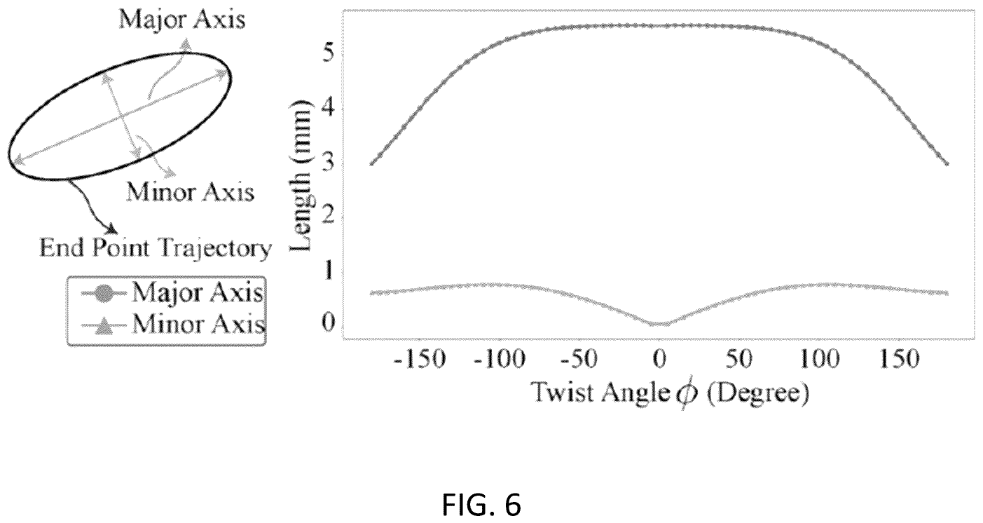

Beam twist versus resulting trajectory. A beam's magnitude of twist influences the generation of elliptical motion, while a beam's chirality (twist direction) can be used to mirror the patterns observed at different magnitudes. The relationship between beam twist angle ¢ and the resulting trajectory was analyzed in two sets of simulations. In the first set, a series of beams were modeled with identical dimensions but a range of twist angles from ϕ=0° to ϕ=180° with a step of 5°. The input amplitude and frequency were held constant at ƒ=15 Hz and A=2 mm. The distal end's trajectory was recorded during the simulation. As the twist angle ϕ increased, the output trajectory's orthogonal motion (along the Y axis) increased. Each trajectory was approximated as an elliptical path, the major and minor axes of the approximate ellipses were identified at each frequency, and the length of the axes were measured. FIG. 6 shows that the evolution of elliptical paths in twisted beams is due at least in part to the twist magnitude and the resulting coupling of stiffness. The twist angle ϕ of the fabricated beams was set as ϕ=90° and ¢=−90° for the more differentiated spans in both major and minor axis.

In the second set of simulations, beams with twist angles of equal magnitude but opposite direction (ϕ1=−ϕ2) were compared, as shown in FIG. 5B. Beams of equal magnitude but opposite chirality result in trajectories mirrored over the Y-axis (the beams' axis of symmetry). The elliptical shape is mirrored and the path orientation along that shape is inverted or mirrored.

Pseudo-rigid-body modeling. To reduce the simulation time for analyzing the beam dynamic behavior, a simplified model that is less computationally expensive was used. A pseudo-rigid-body model was developed to describe the dynamic behavior of twisted beams over time. The model includes revolute springs coupled to a number of joints subdividing the beam. A linear spring-damper model was used of the form

$$τ = k θ + b \dot{θ} \qquad ( 6 )$$

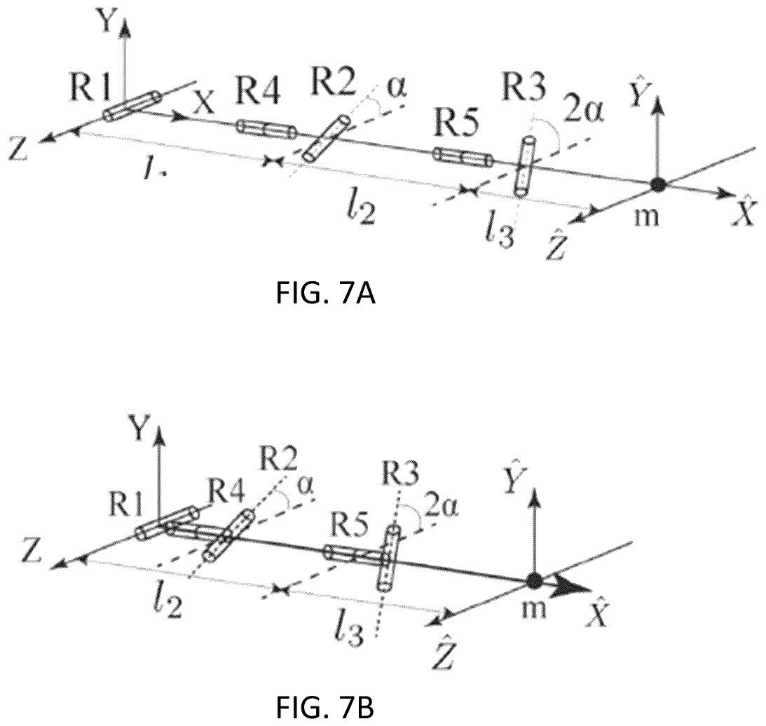

to describe the moments about each joint, where r represents the torque about each joint, k represents the linear spring constant in bending, b represents linear joint damping, and θ, \dot{θ} represent the local rotation and rotational velocity, respectively, of each joint from the joint's unloaded, natural shape. The cross-sectional area of each beam is constant along the axial length. The spring stiffness constant k represents a distributed bending stiffness about three revolute joints (R1, R2, and R3) distributed perpendicularly along the beam's axial direction, as seen in the proposed analytical model depicted in FIG. 7A. A revolute joint, also known as a hinge joint, allows rotation around a single axis e.g., the \hat{X}-axis as seen in FIG. 7A. FIG. 7B shows the simplified analytical model. Two revolute joints (R4 and R5) were aligned with the beam's local axial direction, and capture the twist of the beam, represented by ϕ. The same spring-damper model as represented by Eq. 6 was applied to represent the twisting stiffness on these two joints.

These joints exhibit the same coupled stiffness of twisted beams observed in experiments, as demonstrated through the FEA simulations. The location of joints in a compliant, cantilever-style pseudo-rigid-body model under large-deflections should not be evenly distributed along the beam; thus/l₁, l₂, l₃ were parameterized as the distances between R1-R2, R2-R3, and R3-distal end, respectively. The total length of the beam, l=l₁+l₂+l₃, was set to be the length of the fabricated beam as l=50 mm.

The mass was evenly distributed by the density of thermoplastic polyurethane (TPU) p=1210 kg/m³. The total mass of the beam, or the sum of all links' mass, was set equal to the fabricated beam mass of m=5.17 g. The mass of each link was proportional to the link length, with

$${m}_{k} = \frac{m}{l} .$$

lₖ, where k=1, 2, 3.

Model fitting. A set of dynamic tests was conducted to obtain the motion of the end of the beam when released from an initial deformed state. At the beginning of the test, the beam was deformed with a 200 g load applied to the end. The load was released from the beam while the position of the beam's tip was recorded as the beam returned to rest at the natural unloaded position. Three optical tracking markers were attached to the end of the beam to obtain the tip's motion. After the data was recorded, a differential evolution optimizer was then implemented to fit the model variables (k, b, l₁, l₂, l₃) by minimizing the averaged error between simulation marker position data (Mᵢ) and the reference data from experiments (Mᵢ). The objective function is given by Eq. 7:

$$Min \{ \sqrt{{\sum }_{j = 0}^{n} {\sum }_{i = 1}^{3} [ {( {M}_{i} ( j ) - {\hat{M}}_{i} ( j ) )}^{2} ] / ( 3 n )} \} \qquad ( 7 )$$

The optimization variable set was defined by (k, b, l₁, l₂, l₃), where l₃=50−l₁−l₂. In this fitting progress, the proposed model was simulated. The parameter l₁ typically converged at the minimum bound of 1 mm. The model was simplified by setting l₁=0, yielding the variable set as (k, b, l₂, l₃), where l₃=50−l₂. The optimizer converged with a mean absolute error of 3.49 mm, where k=0.340 N/rad, b=0.0029, l₂=23.66 mm, l₃=26.34 mm.

A pseudo-rigid-body simulation was conducted using the same parameters used for the FEA simulation to compare the results obtained using the simplified model with the more computationally expensive FEA model. During the simulation, the input motor was set to oscillate and actuate one side of the beam from 1 Hz to 45 Hz while the endpoint displacement on the other side of the beam was recorded. As the input frequency increased, the endpoint motion was similar to that in the FEA simulation, transiting from a line to an oval-like orbit that begins to tilt at increased frequencies. The averaged time cost for a 10 s simulation with an Intel i7-7900K CPU and 32 GB RAM was shortened from 82.5 s using FEA model to 1.2 s using the disclosed simplified model.

Simulation of single beam vibration with contact. Using the pseudo-rigid-body model, a series of beam vibration simulations were conducted with contact using the simulation software package MuJoCo. During the simulation, the slider was actuated to sweep from f=1 Hz to f=45 Hz using Eq. 5 with amplitude A=2 mm while the beam's end point position was recorded. The resulting motion differed from the free vibrating beam due at least in part to contact with the floor. A figure ‘8’ loop was observed at the input frequency f=16 Hz and f=26 Hz. The direction of motion at the contact point also changed as a function of the input frequency.

Design, fabrication, and testing of flexible twisted beams. A series of beams were designed and fabricated to validate the disclosed concept. 3 D printing was selected to reduce manufacturing time and to permit a broad design space. Soft printable materials were selected that could be printed at millimeter to centimeter scales, more than 30 layers thick, while achieving the desired range of flexible twisted beam stiffness in all dimensions. Two commercial soft filaments were compared: thermoplastic elastomer (TPE), with a Shore hardness of 92A, and thermoplastic polyurethane (TPU), with a Shore hardness of 95A. The Young's modulus of the TPE selected is reported as 7.8 MPa in the datasheet, whereas the Young's modulus of the TPU is reported as 26 MPa. Although the difference in the hardness between the two materials is small, the TPU 95A's increased stiffness supports the target payload and deflects less at the same dimensions compared to the TPE, while demonstrating the dynamic behavior desired for terrestrial locomotion. Thus, TPU 95A was selected as the fabrication material.

Due at least in part to the simulation results, a number of beams with a twist angle, ¢, of 90° and −90° at the same length (l), width (w), and thickness (t) were fabricated. A flexible twisted beam with a twist angle (ϕ) of ±90° was fabricated. The beam is right-handed chiral if ϕ>0 and left-handed if ϕ<0. Design parameters are defined as depicted in FIG. 3, including a longitudinal axis 302 along the length of the flexible twisted beam 304 from the proximal end 306 to the distal end 308, where the longitudinal axis 302 is perpendicular to the Z-axis 310 along the width of the proximal end 306 and the Z′-axis 312 along a width of the distal end 308. Beams with a twist angle of ϕ=0°, ϕ=±45°, and ϕ=±90° were tested. Values of the design parameters are provided in Table 1.

TABLE 1
Design Parameters

| Parameter | Symbol | Value | Unit |
|---|---|---|---|
| Beam Length | l | 50 | mm |
| Beam Width | w | 20 | mm |
| Beam Thickness | t | 3 | mm |
| Beam Total Twist Angle | f | 90 | degree |
| Beam Segmental Twist Angle | a | 45 | degree |

Single beam contact test. A single beam contact test determined how the output trajectory and the orientation can be influenced by the input signal driving frequency in the presence of nonlinear surface interactions. The test apparatus is shown in FIG. 4. The test apparatus includes a body with a translational stage where oscillating, forward-backward motion was dictated by the rotating crank of a brushless motor. The motor was controlled by an ODrive4 motor control board. Eq. 5 describes the control of the motor speed, with A=2 mm, and f=(1 Hz-40 Hz). The proximal end of the flexible beam was mounted to translational stage and optical tracking markers were mounted to the proximal and distal ends of the beam. An OptiTrack Prime 17W optical motion tracking system was then used to track the position of the system at a rate of 360 Hz. Two pair of load cells, load cell pair Y and load cell pair Z, were mounted to measure contact forces between the foot and surface along the Y and Z axes normal and tangential to the surface, respectively. The beam with ϕ=90° was used, and the mass of the rigid foot was represented by a 20 g load attached to the lower left corner of the load frame. The length of the rigid foot was 66.5 mm, and the distance between the translational stage and the contact plate 418 was h=72 mm. The contact distance between the rigid foot at the unloaded, natural position and the contact plate, h′, was fixed at 5.5 mm.

Typical trajectories were selected. The trajectory evolved as a function of input frequency. In the low-frequency region, where the input frequency is less than 18 Hz, contact interactions dominated the motion observed in the flexible twisted beam, due at least in part to the “foot” typically not breaking contact with the surface. The rigid foot was configured to contact a surface and advance the robotic device along the surface. The direction and speed of the robotic device moving along the surface was due at least in part to the selected input frequency. The “foot” typically not breaking contact with the surface resulted in flat line trajectories along the Z axis. As the input frequency increased to 26 Hz, surface contact was more intermittent, and the motion of the flexible twisted beam was dominated by the beam's own dynamic properties, resulting in trajectories that look like a figure ‘8’, or a loop with a single inversion. At the point of contact, the inverted trajectory resulted in a change in the direction of motion. At frequencies greater than 38 Hz, the trajectory inverted a second time and the direction of motion at the point of contact reversed again.

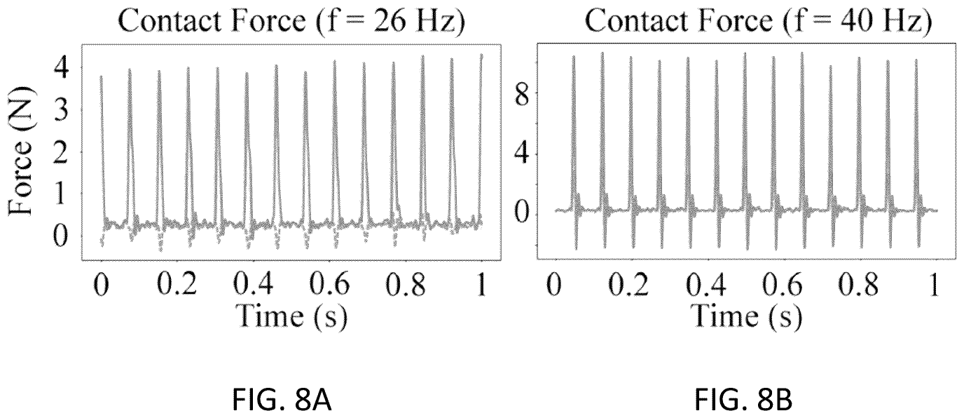

The tangential forces measured by the load cells captured direction changes at the same transition frequencies. FIGS. 8A and 8B show force data sets plotted at frequencies of 26 Hz and 40 Hz, respectively. FIGS. 8A and 8B show that the direction of the tangential forces is opposite for the two frequencies. The vertical force data can be used to capture the contact frequency, which can be different from the input driving frequency. Contact frequencies measured with input driving frequencies from 18 Hz to 44 Hz are shown in FIG. 2. Three distinct contact frequency regimes are observed and highlighted in FIG. 2. In each regime, the contact frequency increased with the input frequency. At the transition frequencies of 26 Hz and 38 Hz, the contact frequency drops by ½ and ⅓, respectively. The transition frequencies of 26 Hz and 38 Hz are the same transition frequencies at which the foot's trajectory inverts and then reverses the direction of motion (and force) on the surface.

Walking tests of a robot. The single beam contact tests were performed with the beam held at a fixed height h from point of contact. Walking tests analyze how a less-constrained flexible twisted beam can produce a controllable walking gait that can be tuned from a single vibrational input.

Two flexible twisted beams serving as robot legs with ϕ=90° and ϕ=−90°, respectively, were mounted in a mirrored fashion across the robot's sagittal plane to a carbon fiber plate. A Maxon brushless motor along with a 40 g offset load was fixed to the plate, serving as a rotary actuation input. A vertical slider connected the robot to two translational stages such that the motion of the robot was constrained along the x-axis and about the yaw axis, while motion was permitted about the roll and pitch axes, and along the z-axis and y-axis. A cart with a 100 g load was attached to the robot's tail for support and balance. The total length of the walking platform was 295 mm.

During this test, the motor was commanded to drive the robot at various frequencies from 1 Hz to 80 Hz in 1 Hz increments. A high-speed camera was used to record the position of the robot at the rate of 1000 fps. In the test, the robot reached the averaged walking speed of 156.3 mm/s with a 65 Hz actuating input frequency. The robot was able to move backward at a speed of 35.7 mm/s at an input frequency of 23 Hz. The robot walking test demonstrates how foot motion can be tuned by altering the one-degree-of-freedom actuation input frequency and can provide for controlling the walking direction and speed by tuning the input actuation frequency.

The simulations and single beam tests with contact demonstrate that the coupled stiffness of flexible twisted beams can be controlled to generate a variety of complex motions by changing the beam's input frequency. Control of speed and direction of motion from actuation sources has been demonstrated, as well as the effect of nonlinear surface contact on the system's dynamic behavior, and how the dynamic behavior can be used to produce a walking gait in a robotic system.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of vibrating a flexible beam, the method comprising:
subjecting a first end of the flexible beam to a linear vibratory input at a selected input frequency, thereby generating a repeating, semicircular trajectory at a second end of the flexible beam,
wherein the flexible beam defines a longitudinal axis along the length of the flexible beam from the first end to the second end, the longitudinal axis is perpendicular to a first axis along a width of the first end and a second axis along a width of the second end, and a twist angle of the flexible beam is defined by an angle between the first axis and the second axis in a plane perpendicular to the longitudinal axis.

2. The method of claim 1, wherein the second end of the flexible beam is coupled to a member, and the member is configured to contact a surface.

3. The method of claim 2, wherein the member is configured to contact the surface to yield a complex motion at the surface.

4. The method of claim 3, wherein the complex motion is adapted for robot walking along the surface.

5. The method of claim 3, wherein the complex motion defines a contact frequency of a contact point at a surface.

6. The method of claim 5, wherein the contact frequency is a function of the selected input frequency.

7. The method of claim 5, wherein a direction of motion at the contact point and a resulting motion path are a function of the selected input frequency.

8. The method of claim 1, further comprising selecting a frequency of the linear vibratory input.

9. The method of claim 5, wherein subjecting the first end of the flexible beam to a linear vibratory input comprises translating the first end of the flexible beam in a plane parallel to a surface of the first end of the flexible beam at the selected input frequency.

10. The method of claim 9, wherein the selected input frequency is in a range of about 1 Hz to about 100 Hz.

11. A robotic device comprising:
a flexible beam;
a body coupled to a first end of the flexible beam; and
a foot coupled to a second end of the flexible beam,
wherein the flexible beam defines a longitudinal axis along the length of the flexible beam from the first end to the second end, the longitudinal axis is perpendicular to a first axis along a width of the first end and a second axis along a width of the second end, and a twist angle of the flexible beam is defined by an angle between the first axis and the second axis in a plane perpendicular to the longitudinal axis.

12. The robotic device of claim 11, further comprising an actuator coupled to the body and configured to translate the body back and forth, thereby moving the flexible beam at a selected input frequency along the first axis.

13. The robotic device of claim 12, wherein the foot is configured to contact a surface and advance the robotic device along the surface.

14. The robotic device of claim 13, wherein a direction and speed of the robotic device along the surface is based at least in part on the selected input frequency.

15. The robotic device of claim 14, wherein the selected input frequency is in a range of about 1 Hz to about 100 Hz.

16. The robotic device of claim 12, further comprising a motor, wherein the motor is operatively coupled to the actuator.

17. The robotic device of claim 11, wherein the twist angle has a magnitude of up to about 90°.

18. The robotic device of claim 11, wherein the flexible beam comprises a material having a Shore hardness in a range of about 90A to about 100A.

19. The robotic device of claim 11, wherein the flexible beam comprises a material with a Young's modulus in a range of about 5 MPa to about 30 MPa.

20. The robotic device of claim 11, wherein the flexible beam comprises a thermoplastic elastomer, a thermoplastic polyurethane, or both.
